(19) United States
(12) Patent Application Publication
(10) Pub. No.: US 2010/0136270 A1
(43) Pub. Date: Jun. 3, 2010

(54) Fluid-fillable article

(76) Inventor: Chuo-Huei Yang, Nantou City (TW)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 12/314,037

(22) Filed: Dec. 3, 2008

(51) Int. Cl. B32B 1/02

(52) U.S. Cl. 428/35.4

(57) ABSTRACT

A fluid-fillable article includes: a fluid-tight envelope made of a polyvinyl chloride (PVC) sheeting material; and an outer layer overlying an outer surface of the envelope and made of a polyurethane material. Preferably, the outer layer includes a functional filler that has a size not larger than a micro size. The fluid-fillable article has the high mechanical properties of PVC and the comfortable hand feel characteristic of polyurethane.

### BACKGROUND OF THE INVENTION

1. Field of the Invention

This invention relates to a fluid-fillable article, more particularly to a fluid-fillable article that includes an outer layer of polyurethane overlying an outer surface of a fluid-tight envelope.

2. Description of the Related Art

A conventional fluid-fillable article, such as an inflatable toy, or an air bed or water bed mattress, is usually made of polyvinyl chloride (PVC) due to its properties, such as high strength, fluid impermeability, and pliability, especially its weldability through a high frequency welding process to form a fluid-tight envelope that can be filled with air or water.

However, PVC material has disadvantages of having pungent odor and providing uncomfortable feel upon touch. In addition, when PVC is produced from vinyl chloride monomer, diisononyl phthalate (DINP) is generally added as a plasticizer which is harmful to human health and which can lead to many diseases such as scleroderma, cancer or allergy.

FIGS. 1 and 2 illustrate a waterbed 1 including a fluid-fillable envelope 11 made of PVC and having a woolen layer 12 formed on the outer surface 13 of the fluid-fillable envelope 11 so as to prevent the PVC material of the envelope 11 from directly contacting the human body. However, formation of the woolen layer 12 requires a complicated processing step, and dust is likely to attach to the woolen layer 12. Moreover, the hairy particles of the woolen layer 12 are prone to separate from the woolen layer 12 and cause respiration problems to people.

### SUMMARY OF THE INVENTION

Therefore, an object of the present invention is to provide a fluid-fillable article that can overcome the aforesaid drawbacks associated with the prior art.

According to the present invention, a fluid-fillable article comprises: a fluid-tight envelope made of a polyvinyl chloride sheeting material; and an outer layer overlying an outer surface of the envelope and made from a polyurethane material.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a perspective view of a conventional waterbed;

FIG. 2 is a fragmentary sectional view taken along line II-II in FIG. 1; and

FIG. 3 is a fragmentary sectional view of a portion of a fluid-fillable article embodying this invention.

### DETAILED DESCRIPTION OF THE PREFERRED EMBODIMENT

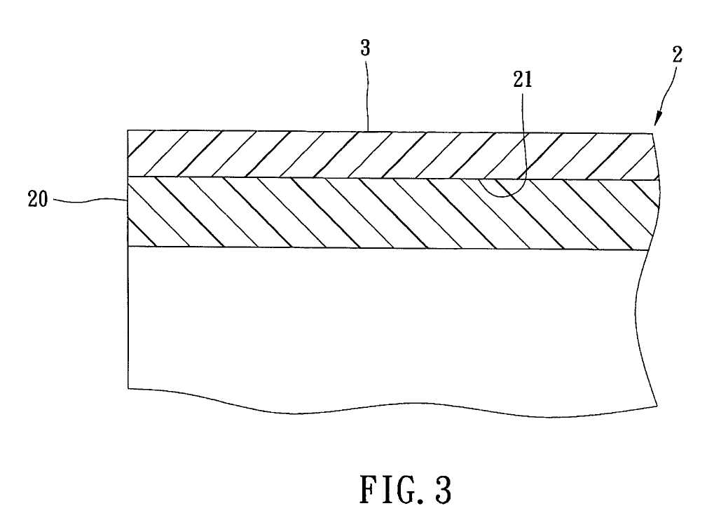

Referring to FIG. 3, there is shown a portion of a fluid-fillable article 2 according to a preferred embodiment of the present invention. The fluid-fillable article 2 includes a fluid-tight envelope 20 that is made of a PVC (polyvinyl chloride) sheeting material, and an outer layer 3. The PVC sheeting material is formed into the envelope 20 by high frequency welding so as to provide an enclosed space to be filled with a fluid, which may be air or water.

The outer layer 3 overlies an outer surface 21 of the envelope 20 and is made from a polyurethane material. In a preferred embodiment, the outer layer 3 is a coating layer having a thickness not larger than 10 μm. The polyurethane material of the outer layer 3 may include a water-based polyurethane or a solvent-based polyurethane. In this embodiment, a water-based polyurethane is used. The water-based polyurethane is coated on the outer surface 21 of the envelope 20, and is then heated under a temperature ranging from 80° C. to 120° C. for curing, thus forming the outer layer 3 on the outer surface 21 of the envelope 20.

In an alternative embodiment, the outer layer 3 is made from a water-based polyurethane containing a functional filler. The functional filler may include one or more materials selected from the group consisting of silver particles, a carbon material, a far infrared radiation material, an anionic material, and nano-sized sheet mica. The filler may be of micro size or nano size. Preferably, the nano-sized sheet mica is used. The amount of the functional filler ranges from 5% to 15%.

The silver particles can provide an anti-bacteria function. The function of the carbon material is to remove foul odor and to inhibit growth of bacteria. The far infrared radiation and anionic materials can release far infrared radiation and anions, which are beneficial to human health. The sheet mica has good scrape resistance, good gas isolating property, and good mold-releasing property.

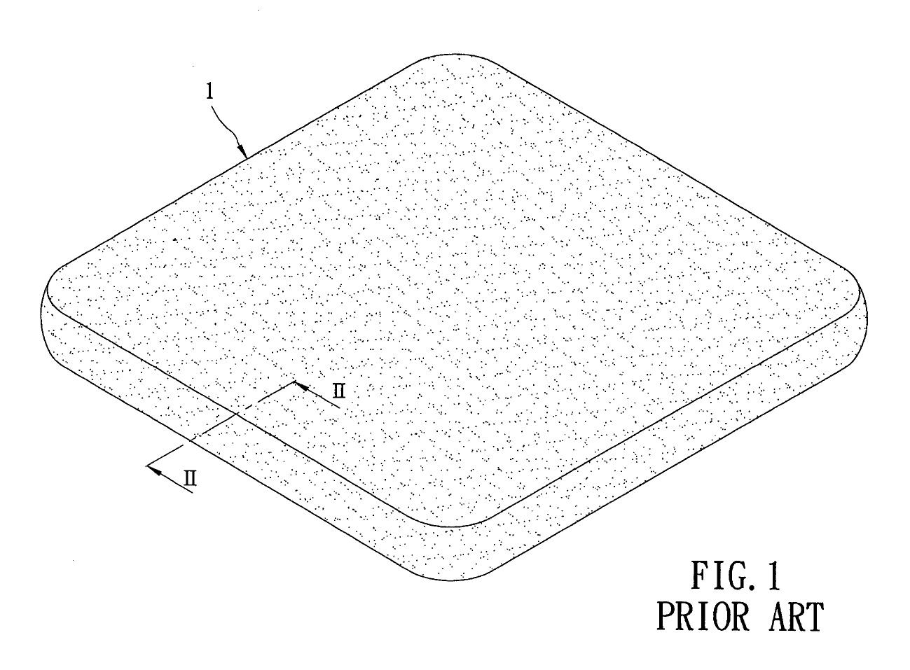

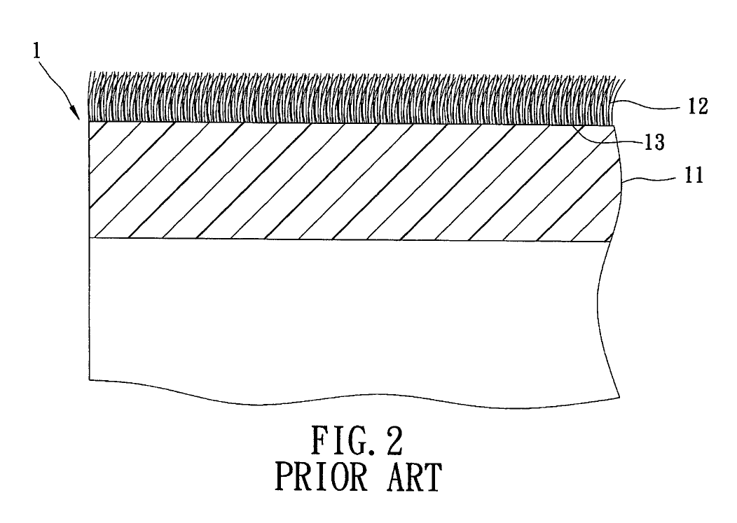

With the use of the polyurethane outer layer 3 that can be easily applied to the PVC envelope 20, the fluid-fillable article 2 according to the present invention can be manufactured in a less-complicated manner compared to the prior art shown in FIGS. 1 and 2. In addition, due to the comfortable feel attributed to the polyurethane and the non-woolen characteristic of the polyurethane, the fluid-fillable article 2 provides the advantages of good hand feel, anti-dust and anti-peeling property. The problems encountered with the prior art can thus be eliminated.

With the invention thus explained, it is apparent that various modifications and variations can be made without departing from the spirit of the present invention. It is therefore intended that the invention be limited only as recited in the appended claims.

What is claimed is:

1. A fluid-fillable article, comprising:
a fluid-tight envelope made of a polyvinyl chloride sheeting material; and
an outer layer overlying an outer surface of said envelope and made from a polyurethane material.

2. The fluid-fillable article of claim 1, wherein the polyurethane material includes a polyurethane selected from the group consisting of a water-based polyurethane and a solvent-based polyurethane.

3. The fluid-fillable article of claim 1, wherein said polyurethane material includes a functional filler.

4. The fluid-fillable article of claim 3, wherein said functional filler has a size not larger than a micro size.

5. The fluid-fillable article of claim 3, wherein said functional filler is selected from the group consisting of silver particles, a carbon material, a far infrared material, an anionic material, sheet mica, and combinations thereof.

6. The fluid-fillable article of claim 3, wherein said functional filler is nano-sized sheet mica.

7. The fluid-fillable article of claim 1, wherein said outer layer is a coating layer.

8. The fluid-fillable article of claim 7, wherein said coating layer has a thickness not larger than 10 μm.
